(19) United States
(12) Patent Application Publication
(10) Pub. No.: US 2026/0077981 A1
(43) Pub. Date: Mar. 19, 2026

(54) HANDLE FOR WINCHES AND THE LIKE

(71) Applicant: ANTAL S.R.L., PADOVA (IT)

(72) Inventors: Roberto CARRARO, Padova (IT); Filippo BRAZZOLOTTO, Mirano (VE) (IT); Luca DE STEFANI, VITTORIO VENETO (TV) (IT)

(73) Assignee: ANTAL S.R.L., PADOVA (IT)

(21) Appl. No.: 19/325,554

(22) Filed: Sep. 11, 2025

(30) Foreign Application Priority Data
Sep. 13, 2024 (IT) 102024000020512

(51) Int. Cl. B66D 1/04; B63B 45/06; B63H 8/20

(52) U.S. Cl. CPC B66D 1/04; B63B 45/06; B63H 8/20; B66D 2700/0116

(57) ABSTRACT

A handle for winches includes an arm with a main longitudinal extension having longitudinally opposing ends, a first end and a second end, respectively, on which there are mounted a coupling member for connection to a winch and a grip, respectively. The coupling member and grip extend from a transversely opposite first face and second face, respectively, of said arm. The handle includes at least one lighting device which can be selectively activated, mounted on the arm in an intermediate position between the Longitudinally opposing ends and orientated to project at least one lighting beam from the first face.

### CROSS-REFERENCE TO RELATED APPLICATIONS

This application claims priority of Italian Patent Application No. IT2024000020512, filed Sep. 13, 2024, the entire contents of which are incorporated by reference herein as if fully set forth.

### FIELD OF THE INVENTION

The present invention relates to a handle for winches and the like and a retrofitting kit for handles for winches.

### BACKGROUND

As is well known, in the nautical field, the winch is a fundamental tool for maneuvering any sailing vessel: it makes it possible to multiply the pulling force exerted to put tension on, for example, a certain rope, against a modest force applied to operate a crank (in nautical jargon “handle”) associated with it.

A winch handle including the features mentioned in the preamble of the main claim is for instance known from EP2581335. This handle requires the axis of the grip to be hollow and accommodates a light source directed downwards. However, this solution has some drawbacks, as the axis of the grip represents a highly stressed part of the handle, which would therefore be weakened by the presence of the cavity housing the light source. In addition, the orientation of the light beam emitted by this design solution does not allow a proper view of the winch drum being implemented, a part that is actually the source of the greatest potential problems when using the winch at night. Irregular or overlapping windings can occur on the drum and on the clam cleat above it, if any, which, if not immediately detected, are a source of serious trouble on the winch-operated rigging line.

A different handle is also known from WO20232774. In this case, there is no actual light source, but a simple signaling LED that serves to verify the correct coupling between the handle and the winch. The LED provided there has no lighting purpose.

Another example of a handle with a signaling LED is described in WO2023036978. Again, the LED only serves to give feedback to the operator and has no lighting purpose.

Finally, it is known from the applicant's own production to make handles for winches whose arm comprises for at least one longitudinal portion thereof two rod-like members spaced apart between which a through recess is defined. This results in a substantial lightening of the handle without compromising its strength.

This handle also has no lighting function.

An omni-directional LED lamp is described in US2018058664A1.

The problem underlying the present invention is to make available a handle for winches, in particular for nautical use, as well as a retrofitting kit for handles for winches, which are structurally and functionally designed to at least partially obviate the drawbacks complained of with reference to the aforementioned prior art.

In the context of this problem, it is an important aim of the invention to provide a handle that is reliable and robust and in particular free of structural weakening in its most critical areas.

Another aim of the invention is to provide a handle capable of facilitating winch maneuvers in precarious visibility conditions in an optimal manner and preferably without impairing the ability to see and recover night vision even when the luminous part of the winch is activated.

A further aim is to provide a handle with extended functionality for user comfort, night vision and reading, and the typical needs of the yachtsman in both navigation and mooring.

Finally, it is an important aim to make a handle that lends itself to easy retrofitting of existing products.

### SUMMARY

This technical problem is solved and these and other purposes are achieved by the invention through the implementation of a winch handle incorporating one or more of the features defined by the appended claims.

According to a first important aspect of the invention, a handle for winches and the like comprises an arm with a main longitudinal extension having longitudinally opposing ends to which a coupling member for connection to a winch and a grip are respectively mounted. Typically, the coupling member comprises an eight-pointed star profile shank preferably mounted with a transverse axis and preferably perpendicular to the longitudinal extension of the arm, extending from the first face thereof.

The grip generally extends from a second face of the arm, opposing the first, at the opposing longitudinal end with respect to the coupling member and preferably comprises a body rotating freely about an axis transverse to the arm.

In a preferred solution, the handle comprises a lighting device which can be selectively activated, which is preferably mounted on the arm in an intermediate position between the longitudinally opposing ends. Preferably the lighting device is oriented to project at least one lighting beam from the first face.

In this way, the lighting device fulfils several functions, including that of allowing improved surveillance of the winch, when the handle is coupled with it, to verify the correct winding of the rope on its drum.

The present invention may also have one or more of the following preferred features in addition to those mentioned above.

In embodiments, the lighting beam (or the light source that generates it) may form an angle comprised between 10° and 80°, preferably between 20° and 70°, even more preferably between 30° and 60°, with respect to the main longitudinal extension of the arm.

In a preferred solution of the invention, the lighting device comprises at least one light source configured to generate its first light beam directed towards the coupling member. This preferred orientation makes it possible to monitor the most delicate part of the winch, i.e. the clam cleat member above it, which serves to allow the rope to be wound onto the drum without retaining its sleeping end.

In a further preferred version of the invention, the arm comprises at least one recess on its first face that serves as a housing seat for the lighting device.

The lighting device can thus be partially or fully recessed in this recess, avoiding protrusions from the handle arm.

It is further preferable that the arm comprises for at least one of its longitudinal portions two rod-like members spaced apart between which a recess is defined by a through-opening constituting the seat of the lighting device. This structure fits the current known conformation of the handles sold by the applicant, allowing them to be easily retrofitted.

It should be noted that, in this context, “rod-like member” preferably means an elongated member.

In a preferred form, the lighting device comprises a casing configured for positive-locking or snap-fitting connection to the seat. This allows quick and easy interchangeability, mounting and/or removal of the lighting device from the handle arm for any user.

In a further preferred form, the casing comprises two half-shells and at least one coupling element between the two half-shells. Preferably this at least one coupling element comprises one or more screws. Preferably the screws can be self-tapping. Preferably the two half-shells are sealed with a watertight gasket (e.g. IP64 or IP65) to prevent accidental entry of water into the casing. Preferably, the half-shells are profiled with opposing flanks susceptible to positive-locking with the rod-like members when the casing is inserted into the seat.

In a preferred version, the half-shells each have an internal transverse recess at the respective first and second coupling ends. Preferably, each of the inner transverse recesses has a portion intended to abut against a flanged edge of the arm, at least partially defined between the rod-like members. This allows the device to be mounted and coupled to the arm in a solid and sturdy manner, and prevents the device accidentally leaving its seat during use.

In an alternative preferred version, but one that may possibly be combined with the one described above and may thus have one or more of the features described in relation to it, the casing comprises a main box-shaped member with which a longitudinal extension is associated. Preferably the main box-shaped member has an elongated shape with longitudinally opposing ends. Preferably the longitudinal extension protrudes from one of said ends. Preferably the longitudinal extension is associated with the box-shaped member at a transverse end portion of the latter. Preferably, the longitudinal extension has a region configured to be coupled to at least one releasable connection element, especially at least one screw element. In a preferred example, the longitudinal extension has an opening, in particular a through-opening, intended to house at least one connection element with the arm of the handle. This geometric conformation of the lighting device provides the advantage of having a device that is essentially watertight and consists of a single, pre-assembled element, which can be mounted on the arm of the handle even by inexperienced users easily and smoothly.

In a preferred form, the light source comprises at least one LED bulb. Preferably, the bulb emits at a wavelength that does not disturb night vision. Preferably, the emission takes place in the red and/or blue range. This feature means that human eye rods are not disturbed, making it easy to recover normal night vision.

In preferred forms, at least one bulb is configured to generate a second white light beam. Preferably the second beam is diffused from the first face. Preferably the bulb is of the LED type. The bulb can be the same one that generates the first light beam or an additional bulb. This generation allows the handle to be used as a reading light in the cockpit.

In further preferred forms, the light source comprises a bulb configured to generate a third white light beam of greater intensity than the intensity of the second light beam. Preferably the bulb is LED. Preferably white light is diffused from the first face. This feature allows the handle to be used as an emergency battery, if necessary, to illuminate sails subject to adjustment, for example. Alternatively, the intensity of the third beam may be less than the intensity of the second beam.

In embodiments, the lighting device internally houses a replaceable battery.

In alternative embodiments, the lighting device internally houses a rechargeable battery. This means there is no need to replace the battery every time it is substantially discharged and there is no need for the user to always have batteries compatible with the power supply of the lighting device.

Of course, it is also provided that the battery can be both replaceable and rechargeable.

Preferably, the battery is rechargeable via a defined electrical socket on the handle. Preferably, the charging socket is a USB type.

Alternatively, or additionally, the battery can be recharged via an electric charging socket provided on the winch itself. Preferably, the charging socket is defined substantially at the coupling seat of the coupling member. The feature is particularly useful in the case of an electric winch, as it is then possible to derive the battery charging current directly from the winch power supply.

According to a further important aspect of the invention, a retrofitting kit for handles for winches includes a selectively activatable lighting device. Preferably the lighting device comprises a casing with a main longitudinally extension with longitudinally opposing ends, said casing being inserted into a seat of the handle. The lighting device further comprises at least one light source, preferably angled in the direction of one of the longitudinally opposing ends of said casing.

This allows the lighting device to be mounted along the arm of the handle in such a way that the light beam emitted by the source can illuminate the area of the coupling member.

This kit advantageously allows existing handles to be fitted with the lighting device described herein without the need to replace old handles.

In embodiments, the light source is configured to generate a light beam that forms an angle comprised between 10° and 80°, preferably between 20° and 70°, even more preferably between 30° and 60°, with respect to the main longitudinal extension of the casing.

Preferably, the lighting device casing is configured to be coupled to the handle seat at its side walls, while the light source is preferably housed at the base wall of the casing.

In addition to the above features, the lighting device comprised in the kit may also have one or more of the features described in connection with the first aspect of the invention.

It is also provided that the kit may comprise at least one releasable connection element, in particular of the threaded type (e.g. one or more screws), to attach the lighting device to the handle.

It should be noted that, in this context, the term “handle” is preferably intended as nautical jargon for a crank handle.

It is specified that, in this description, terms such as “upper”, “lower”, “internal”, “external” etc. refer to the configuration of use of the lighting device and/or handle.

### BRIEF DESCRIPTION OF THE DRAWINGS

The features and advantages of the invention will become clearer from the detailed description of two preferred but not exclusive embodiments thereof, illustrated below with reference to the accompanying drawings:

FIG. 1 is an overall and partially exploded perspective view of the handle according to the invention associated with a winch, in a first embodiment thereof;

FIG. 2 is a perspective view of the handle shown in FIG. 1;

FIG. 3 is an orthogonal side elevation view of the handle shown in the previous figures;

FIG. 4 is an orthogonal plan view from below of an enlarged scale detail of the handle depicted in the previous figures;

FIG. 5 is an orthogonal plan view from above of the handle shown in the previous figures;

FIG. 6 is an orthogonal plan view from above of the lighting device according to the invention;

FIG. 7 is an orthogonal plan view from below of the lighting device shown in FIG. 6;

FIG. 8 is a side elevation orthogonal view of the lighting device depicted in FIGS. 6 and 7;

FIG. 9 is an orthogonal front elevation view of the lighting device depicted in FIGS. 6 to 8;

FIG. 10 is a cross-sectional view, taken along plane X-X, of the lighting device shown in FIG. 8 in its side elevation view;

FIG. 11 is a longitudinal section of the handle according to the invention in a second embodiment thereof.

### DETAILED DESCRIPTION OF THE PREFERRED EMBODIMENTS

In the examples in the figures, 1 indicates a handle made in accordance with the present invention.

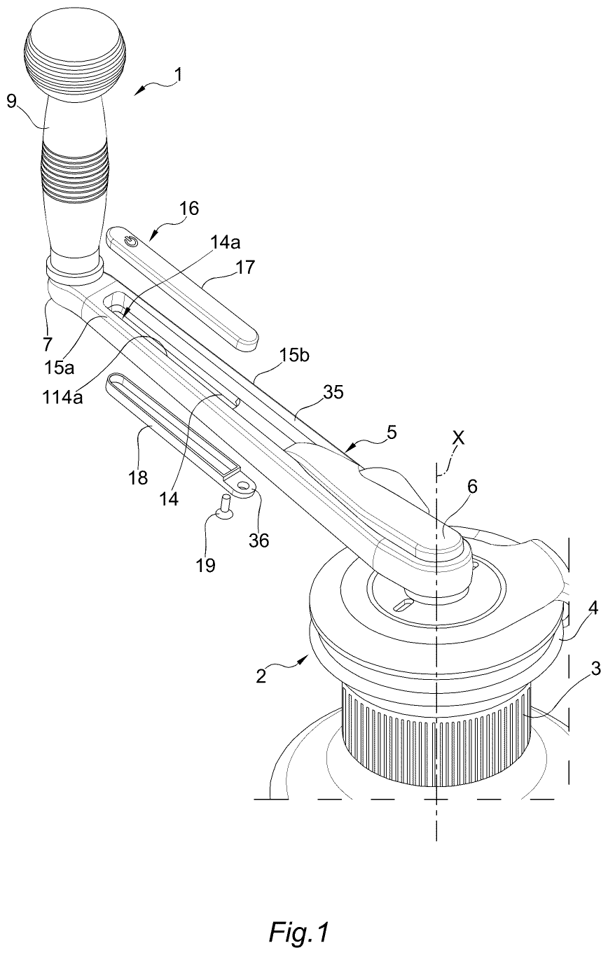

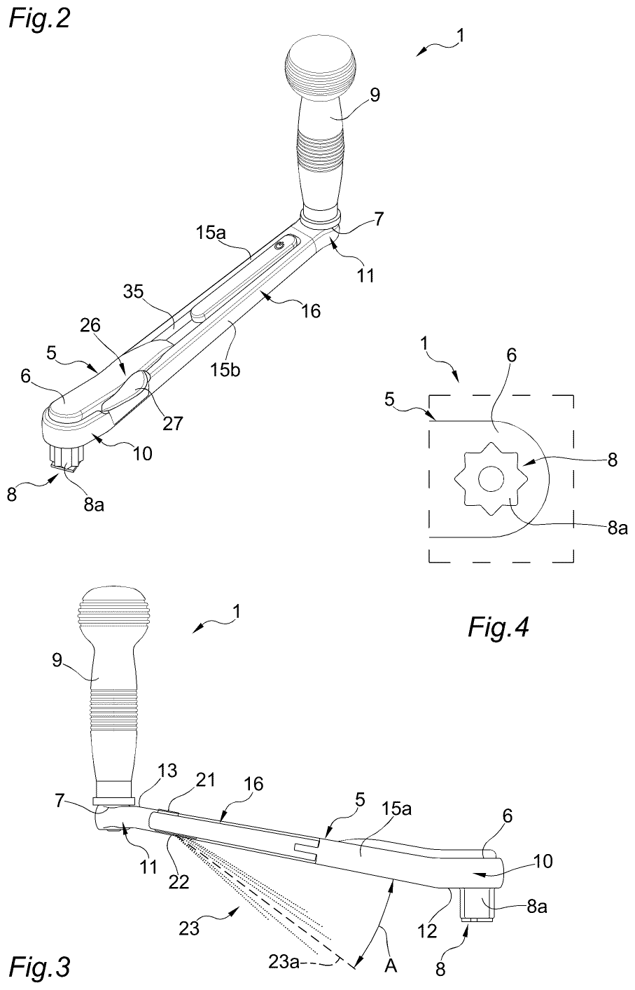

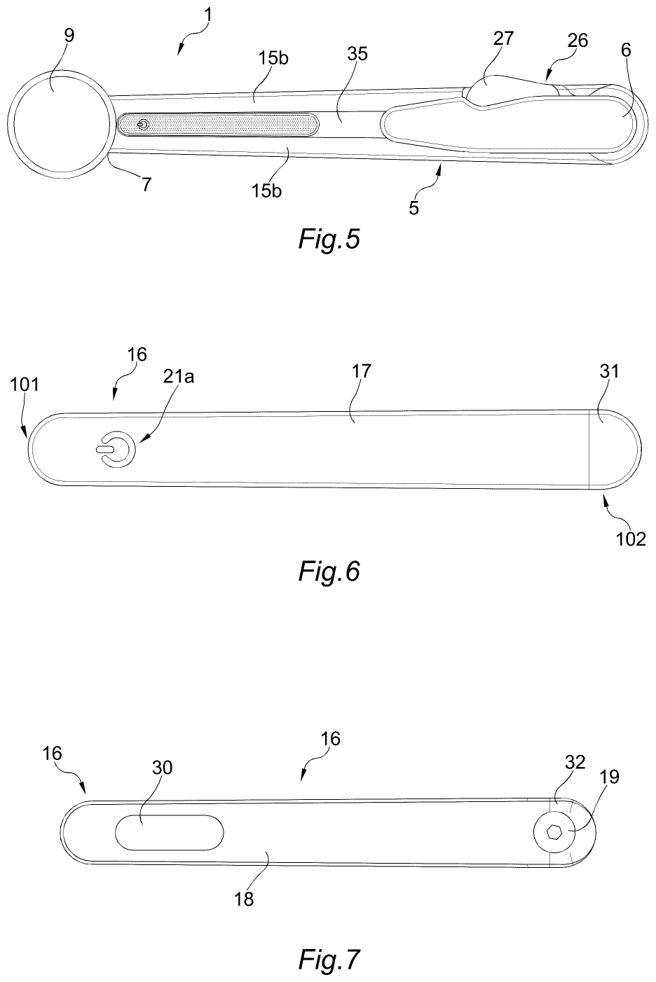

With particular reference to the example in FIGS. 1 to 5, the handle 1 is used to rotate about its own axis X a drum 3 of a winch 2, preferably but not necessarily equipped with a clam cleat 4, better known in the industry as a “self-tailing” device. As a result of this rotation, a rope not shown wound onto the drum 3, and possibly held in the self-tailing device 4, can be hauled or released depending on the required maneuver.

The handle 1 in turn comprises an arm 5 with a main longitudinal extension, having longitudinally opposing ends, a first end 6 and a second end 7, respectively, on which there are mounted a coupling member 8 for connection to the winch 2 and a grip 9.

In the example illustrated, the arm 5 has, at the ends 6 and 7, respective folded zones, respectively a first folded zone 10 and a second folded zone 11; these lie in essentially parallel and spaced apart planes and essentially serve to distance the arm 5 progressively from the drum 3 in the direction of the axis X, in order to facilitate its actuation, as can be seen in the example in FIG. 1 in which the handle 1 is coupled to the winch 2. These folded areas can be omitted (one or both) in different types of handles.

Typically, the coupling member 8 comprises a eight-pointed star profile shank 8a preferably mounted with a transverse axis and preferably perpendicular to the plane of the respective first folded zone 10, extending from a first face 12 of the arm 5, to which reference will also be made below as the “lower page” of the arm itself. Alternatively, a square shank or other suitable coupling element for torque transmission can be used.

It is provided, in a manner known per se, that this shank 8a may be equipped with a retaining device 26 operable through a spring-loaded lever 27 to lock the handle 1 axially on the winch 2 and prevent its accidental removal.

The grip 9 generally extends from a second face 13 of the arm, opposing the first face 12, and the opposing longitudinal end identified by the reference 7, at the second folded area 11, preferably comprises a freely rotatable body about an axis transverse to the longitudinal extension of the arm 5 so as to be substantially vertical under normal conditions of use. Preferably, the axes of the handle 1 and shank 8a are parallel to each other.

In an intermediate zone of the arm 5, proximal to the grip 9, at least one recess 14a is formed, constituting a seat 114a for housing a lighting device 16. In an embodiment not illustrated in the figures, the recess 14a is made on the first face or lower page 12 and is essentially defined by a blind-hole seat, which acts as a support abutment for a face of said lighting device 16 which is inserted into the blind-hole seat on the side of the first face 12.

In the first embodiment depicted in the figures, however, the recess 14a defines the seat 114a by way of at least one (or more) through opening(s) 14, which identifies on the arm 5 two rod-like members, respectively a first rod-like member 15a and a second rod-like member 15b, approximately parallel.

The opening 14 then defines the housing seat for the lighting device 16 mounted on the arm 5 in an intermediate position between its longitudinally opposing ends 6 and 7 and oriented to project at least one light beam from the first face 12, i.e., downwards from the arm 5 itself.

Preferably the light source or its light beam forms an angle A comprised between 10° and 80°, preferably between 20° and 70°, even more preferably between 30° and 60°, with respect to the main longitudinal extension of the arm 5.

In alternative embodiments not illustrated in the figures, the number of seats 114a can be variable both in form, number and spatial location on the arm 5. For example, multiple lighting devices 16 may be placed in corresponding, alternatively blind and/or through-hole seats 114a, arranged adjacent along the longitudinal extension of the arm 5, along its transverse extension, or both. This embodiment could be preferred in the case of choosing to use, for example, several relatively low-powered lighting devices 16 or to obtain a larger light beam, useful for example in the case where the winch 2 with which the handle 1 is to be associated is large.

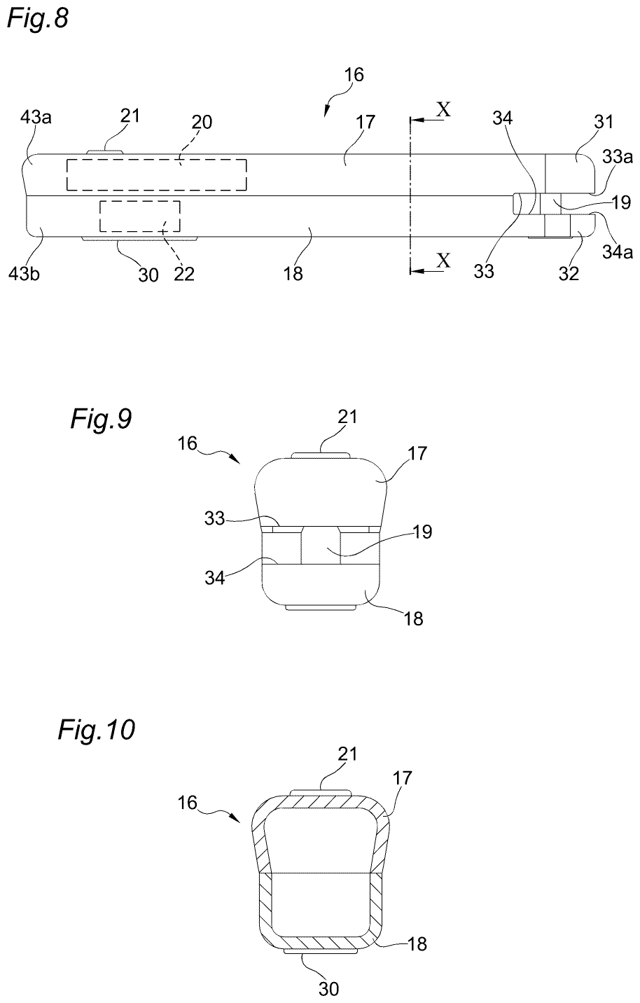

With particular reference to the example of FIGS. 6 to 10, preferably, the lighting device 16 in its first embodiment comprises a casing including two half-shells, an upper half-shell 17 and a lower half-shell 18, respectively, coupled together via coupling elements 19 comprising one (or more) screw(s) (also referred to below by the same reference number 19). Inside the casing there are housed a battery 20 and a light source 22, preferably a light bulb (identified hereafter by the same reference 22); this bulb 22 is preferably LED and is such as to generate, when activated through a switch 21, one or more light beams, possibly different from each other. For example, the battery 20 is placed inside the upper half-shell 17, while the bulb 22 can be placed inside the lower half-shell 18; both are shown schematically in the example in FIG. 8. Alternatively, in an embodiment not shown in the figures, the battery 20 and the bulb 22 can also be placed inside the same half-shell 17 or 18.

The switch 21, located substantially at the top of the upper half-shell 17, can be advantageously identified by graphic signs 21a on the outer surface of the upper half-shell 17; for example, as in the case of the embodiment depicted in the above figures, the graphic signs 21a can be defined by an on/off symbol, so as to facilitate a user who has to operate the lighting device 16. Alternatively, the graphic signs 21a may bear the words “ON” and “OFF”, for example.

In the case where the geometrical conformation of the housing seat of the lighting device 16 is blind and the latter is inserted therein on the first face 12, the switch 21 could be placed at the top of the lower half-shell 18 or in any case on the surface of the lighting device 16 facing downwards. Alternatively, it could still be located substantially at the top of the upper half-shell 17 if provision is made for any openings at the bottom of the seat to allow access to said switch 21 by the user.

Firstly, e.g. as a consequence of a first pressing of the switch 21, the bulb 22 generates a first light beam 23 (schematically represented in the example in FIG. 3) preferably directed towards the coupling member 8 and preferably of a wavelength such that it does not disturb night vision. Typically, such light emission will have wavelengths in the red or blue range, emissions that have the inherent prerogative of not disturbing human eye rods, thus making it easy to recover normal night vision.

The same or another bulb 22 may also generate diffused downward lighting (not shown in the figures) of the handle 1, i.e. from its first face or lower page 12, e.g. white light of reduced intensity. This generation allows the handle 1 to be used as a “reading light” in the cockpit, particularly if the winch 2 on which the handle 1 is installed is mounted on the deckhouse. This beam is emitted as a consequence of, for example, a second pressing of the switch 21.

A third emission (also not shown) is provided at the third pressing of the switch 21 with a white light beam of greater intensity, allowing the handle 1 to be used as an emergency battery to illuminate, for example, sails subject to adjustment.

The lower half-shell 18 is provided with one (or more) window(s) 30 through which the light beam generated by the bulb 22 (and possibly also by the further bulbs within the device) is visible outside the lighting device 16, oriented variably as a result of each of the pressures exerted on the switch 21 as described above. The window 30 is preferably made of a substantially transparent material and can be, for example, glass and/or plastic.

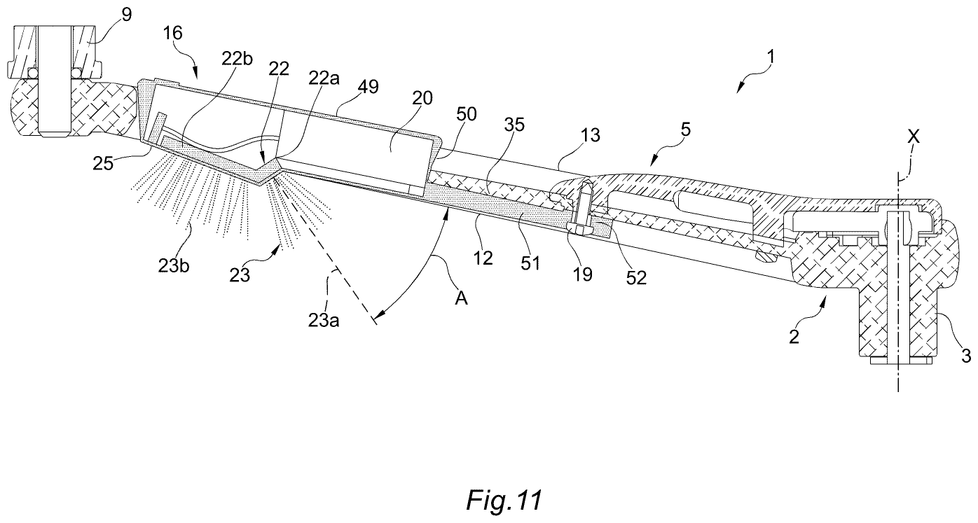

The battery 20 may be of the replaceable or rechargeable type. In the latter case, an electrical charging socket 25 (illustrated by way of example in FIG. 11), e.g. USB or similar, is provided on the casing (or elsewhere on the handle 1). It is also provided that recharging can be carried out via an electrical socket provided on the winch 2 (also not shown in the figures), e.g. at the coupling seat of the shank 8a; in this way, the lighting device is electrically connected to the winch 2 when the handle 1 is engaged on it and the battery 20 is thus recharged. The feature is particularly useful in the case of an electric winch 2, as it is then possible to derive the charging current for the battery 20 directly from the power supply of the winch 2.

As shown in the example in FIG. 6, the casing of the lighting device 16 has an elongated shape with longitudinally opposing ends 101, 102.

Preferably, the casing of the lighting device 16 is shaped in such a way that it can be positive-locked or snap-fitted to the seat identified by the through opening 14.

In such a case, the half-shells 17 and 18 are preferably profiled with opposing flanks that can be positive-locked to the rod-like members 15a and 15b when the casing is inserted into the aforementioned seat of the handle 1.

More particularly, the two half-shells 17 and 18 have a substantially parallel longitudinal extension, in the use configuration, to the longitudinal extension direction of the arm 5 and consequently of the rod-like members 15a and 15b. Each of them, as can be seen in FIG. 8, substantially at the respective first and second coupling ends 31 and 32, has an internal transverse recess, identified for the upper half-shell 17 as the first internal transverse recess 33 and for the lower half-shell 18 as the second internal transverse recess 34.

The term “internal transverse recess” refers to a decrease in the transverse thickness of each of the half-shells 17 and 18 from their mutual coupling surface. Alternatively, the inner transverse recess may be defined on only one of the two half-shells, either the upper 17 or the lower 18.

The surfaces of the recesses 33 and 34 are intended to face each other when the half-shells 17 and 18 are coupled together via the screw 19. A respective first end portion 33a and second end portion 34a are instead intended to abut a flanged edge 35 of the arm 5, which is defined at least partially between the rod-like members 15a and 15b of the arm 5 and which delimit the through-opening 14.

More particularly, the lower half-shell 18 is provided with a through-hole 36 and the upper half-shell 17 with a blind hole preferably threaded (not shown in the figures) for their mutual coupling via the screw 19. Alternatively, the through-hole can be defined on the upper half-shell 17 and the blind hole on the lower half-shell 18; the first configuration described above makes the handle 1, coupled with the lighting device 16, more aesthetically pleasing, since the coupling screw 19 is located on the side of the first face 12 and is therefore hidden from a user's view. Alternatively, the screw 19 can also be of the self-tapping type.

In fact, the assembly step requires the two half-shells 17 and 18 to be placed on opposite sides with respect to the arm 5, more particularly on the side identified by the second face 13 and the first face 12, respectively. The screw 19, in engagement for example with the through-hole 36, is tightened to approach the half-shells 17 and 18, whose end portions 33a and 34a contact opposite sides of the flanged edge 35 and face the second face 13 and the first face 12. In this embodiment, the screw 19 is placed—in use—within the seat identified by the through opening 14.

In an alternative embodiment not depicted in the figures, the flanged edge 35 has an additional through-hole, intended to be aligned with the through-hole 36 and the blind hole defined on the respective half-shells 17 and 18. In this way, the coupling between the half-shells 17 and 18 and the association of the resulting casing with the handle 1 results from the alignment of three aforementioned holes, which are engaged simultaneously by the screw 19.

Further end portions of the half-shells 17 and 18, longitudinally opposing the end portions 33a and 33b intended to abut on the flanged edge 35 and identified respectively by the reference numbers 43a and 43b (facing, in use, towards the grip 9), have a geometrically specular conformation with a perimeter widening. In more detail, each of the half-shells 17 and 18 has a perimeter widening with a progressive increase outward, i.e., passing from the contact surface of the two half-shells 17 and 18 to the surface facing the user. In this way, each of the longitudinal widenings can substantially abut on the internal profile of the through opening 14.

In a second, alternative embodiment illustrated in the example in FIG. 11 in a sectional view thereof, the casing consists directly of a single body, which can however be opened to allow access to internal components such as the battery and/or the bulb (e.g. for their replacement in case of malfunctioning), which can be coupled to the arm 5 through insertion into the appropriate seat directly from either side of the arm 5.

More particularly, in this case, the casing of the lighting device 16 is essentially constituted by a main box-shaped member 49 with which there is associated, in the region of a transverse end portion 50 thereof, a longitudinal extension 51 known in the jargon as a “tail” and indicated hereinafter by the same reference number.

In the vicinity of the longitudinal end opposing that of association with the box-shaped member 49, the tail 51 has a region suitable for being connected with at least one screw element and preferably with one (or more) screws 19 preferably self-tapping. Preferably, the longitudinal extension has an opening 52 intended to house at least one screw element. The screw 19, in engagement with the tail 51 and with the body of the arm 5 of the handle 1 with which it is intended to come into contact, thus creates the coupling of the lighting device 16; the latter, even in the case of the present embodiment, nevertheless has profiled sides to create a shape coupling with the seat 114a.

Preferably the light source 22 comprises a first bulb 22a (possibly an LED bulb) configured to generate a first light beam 23a, preferably red light. Preferably, the first bulb 22a (or the first light beam 23a) forms an angle A comprised between 10° and 80°, preferably between 20° and 70°, even more preferably between 30° and 60°, with respect to the main longitudinal extension of the casing or arm.

Preferably, the light source 22 comprises a second light bulb 22b (possibly an LED bulb or LED strip) configured to generate a second light beam 23b, preferably in white light, and possibly a third light beam, also preferably in white light, of greater or lesser intensity than the intensity of the second light beam. Preferably the second bulb 22b is oriented to project from the first face 12, i.e. downwards from the arm 5.

The embodiment in FIG. 11 may have one or more of the characteristics described with reference to the examples in FIGS. 1-10, and vice versa.

The assembly of the device 16 in the embodiment just described on the arm 5 takes place as follows: the tail 51 of the casing is inserted into the through opening 14 from the side identified by the second face 13 and is placed in contact with the flanged edge 35 at the first face 12.

Thus realized, the lighting device 16 in all the embodiments proposed in the present description is substantially suitable to be proposed as a retrofitting kit for existing handles for winches, in particular for handles manufactured by the same applicant and having the through opening 14 between the two rod-like members 15a and 15b of the arm 5.

The operation of the handle 1 according to the invention seems clear and intuitable from what has been described so far. After mounting the lighting device 16 on the arm 5 of the handle 1 itself (in the manner described above, depending on its geometric conformation), the light beam 23 emitted as a result of one or more presses on the switch 21 illuminates the area of the coupling member 8 and/or the region below the first face 12 with a variable power.

In practice, it was found that the invention achieves its task and purposes by providing a reliable and robust handle that facilitates winch maneuvers in poor or precarious visibility conditions. In addition, the handle was found to be suitable for refitting existing products.

1. A handle for winches comprising an arm with a main longitudinal extension having longitudinally opposing ends, respectively, a first end and a second end, on which there are mounted a coupling member for connection to a winch and a grip, respectively, said coupling member and grip extending from a transversely opposite first face and second face, respectively, of said arm, said handle comprising at least one lighting device which can be selectively activated, wherein said at least one lighting device is mounted on said arm in an intermediate position between said longitudinally opposing ends and is orientated to project at least one lighting beam from said first face.

2. The handle according to claim 1, wherein the at least one lighting device comprises at least one light source which is configured to generate a first light beam which is orientated towards said coupling member.

3. The handle according to claim 1, wherein said arm comprises at least one recess on said first face, said at least one recess constituting at least one seat for receiving said at least one lighting device.

4. The handle according to claim 3, wherein said arm comprises, over at least a longitudinal portion thereof, at least two rod-like members, at least a first rod-like member and at least a second rod-like member, respectively, which are spaced apart from each other and between which said at least one recess is defined by at least one through-opening which constitutes said at least one seat.

5. The handle according to claim 3, wherein said at least one lighting device comprises a casing which is configured for positive-locking or snap-fitting connection to said at least one seat.

6. The handle according to claim 5, wherein said casing comprises two half-shells, an upper half-shell and a lower half-shell, respectively, and at least one coupling element between said half-shells, said half-shells being profiled with opposing flanks which are configured for positive-locking to the rod-like members when said casing is inserted into said at least one seat.

7. The handle according to claim 6, wherein said half-shells, substantially at respective first and second connection ends, each have an internal transverse recess, the surfaces of which are configured to face each other when said half-shells are connected to each other, said internal transverse recesses each being provided with an end portion which is configured to abut a flanged edge of said arm which is defined at least partially between said rod-like members and which delimits said through-opening.

8. The handle according to claim 5, wherein said casing comprises a main box-shaped member with which there is associated, at a transverse end portion of said main box-shaped member, a longitudinal extension having, near the opposite longitudinal end with respect to the one being associated with said main box-shaped member, a region adapted to be connected with at least one screw element.

9. The handle according to claim 2, wherein said at least one light source emits at a wavelength in at least one of the red or blue fields, such as not to disturb night vision.

10. The handle according to claim 2, wherein said at least one light source comprises at least one first LED lamp which is configured to generate said first light beam.

11. The handle according to claim 2, wherein said at least one light source comprises at least one second LED lamp which is configured to generate at least one of a second or third light beam with white light, is diffused by said first face, with intensity greater than or less than the intensity of the second light beam.

12. The handle according to claim 1, wherein said lighting device internally houses a battery which can be replaced and/or recharged.

13. The handle according to claim 12, wherein said battery is rechargeable through a USB-type electrical recharging socket which is defined on said handle.

14. The handle according to claim 12, wherein said battery is rechargeable through an electrical recharging socket which is provided on said winch substantially in the region of the coupling seat of said coupling member.

15. The handle according to claim 1, wherein said first face identifies a lower page of the arm with reference to the configuration of use of the handle.

16. The handle according to claim 1, wherein said lighting device performs the function of allowing improved surveillance of the winch when the handle is engaged thereon.

17. A retrofitting kit for winch handles, comprising a lighting device which can be selectively activated, said lighting device comprising a casing having a main longitudinal extension with a first and a second longitudinally opposed ends, wherein said casing is insertable into a seat of the handle and has profiled flanks configured to realize a positive-locking with said seat, wherein said second end has an opening configured to receive a fastening screw with said seat, and wherein said lighting device comprises at least one light source angled in a direction of said second end.

18. The retrofitting kit according to claim 17, wherein said casing comprises a main box-shaped body to which, at a transverse end portion of said main box-shaped body, a longitudinal extension is associated, wherein said longitudinal extension projects longitudinally with respect to said main box-shaped body so as to define said second end near the longitudinal end opposite to that associated with said main box-shaped body, wherein said opening is formed in said longitudinal extension at said second end.

19. The retrofitting kit according to claim 18, wherein said main box-shaped body internally houses a replaceable and/or rechargeable battery.

20. The retrofitting kit according to claim 17, wherein said at least one light source emits at a wavelength in at least one of the red or blue fields so as not to disturb night vision.
